(19) United States
(12) Patent Application Publication
(10) Pub. No.: US 2022/0347818 A1
(43) Pub. Date: Nov. 3, 2022

(54) BLASTING MEDIUM AND METHOD OF SURFACE TREATMENT USING SUCH A BLASTING MEDIUM

(71) Applicant: SANFRAN AIRCRAFT ENGINES, Paris (FR)

(72) Inventors: Hugo SISTACH, MOISSY-CRAMAYEL (FR); Cédric Pierre Jacques COLAS, MOISSY-CRAMAYEL (FR); Terence GRALL, MOISSY-CRAMAYEL (FR); Romaric Jean-Marie PIETTE, MOISSY-CRAMAYEL (FR)

(73) Assignee: SAFRAN AIRCRAFT ENGINES, Paris (FR)

(21) Appl. No.: 17/616,758

(22) PCT Filed: Jun. 7, 2020
(86) PCT No.: PCT/FR2020/050967

§ 371 Date: Dec. 6, 2021

(30) Foreign Application Priority Data
Jun. 7, 2019 (FR) FR1906076

(51) Int. Cl. B24C 1/00; C01B 32/55

(52) U.S. Cl. CPC B24C 1/003; C01B 32/55

(57) ABSTRACT

A blasting medium includes first ice particles and second particles having a hardness between 2000 and 2500 HV. The second particles are embedded in the surface and in the volume of the first particles.

### TECHNICAL FIELD OF THE INVENTION

The invention relates to the cleaning and treatment of the external surfaces of a part with a media (which can be called a “medium” in the singular form) for sandblasting, the part usefully being a part such as an aeronautical part.

A cleaning and/or surface treatment method is therefore concerned, which proposes to project such a pressure blasting medium onto the surface to be treated. The present invention is particularly suitable for cleaning and processing parts obtained by an additive manufacturing method.

### PRIOR ART

The parts obtained by an additive manufacturing method have a high level of roughness with an arithmetic roughness of the profile (Ra) ranging from 5 μm to 50 μm. A first factor that contributes to this roughness is associated with the layering technique of the additive manufacturing method, which creates a stairs effect like the part shown in FIG. 1. The presence of this roughness can cause functional and mechanical problems in a mechanical assembly. Another factor that contributes to roughness is the presence of powder grains that are agglomerated on the surface of the part. These powder grains agglomerated on the surface can escape during operation of the part and can damage the mechanical system associated with the part, such as an oil circuit. These grains can also escape during handling by an operator and can present a health and environmental risk. Finally, for parts obtained by additive manufacturing, it is necessary to remove any residual powder that has fused during the manufacturing. This is done with a brush and hoover, but this is not sufficient. In addition, in some cases, whenever this step has been omitted and the part has been heat treated, it is not possible to remove the powder that will have sintered to the part due to the thermal effect.

In order to fully exploit the performance of an additive manufacturing part, it is therefore imperative to remove the surface roughness and residual powder grains present on the surface. For this purpose, it is known to use a blasting technique based on corundum particles to reduce the roughness. This technique consists of projecting corundum particles under pressure onto the surface of the part to be treated. This technique reduces the roughness but presents a significant risk of contamination to the part. This is because the corundum particles can be embedded in the surface of the part when the corundum particles impact with the surface of the part. This incrustation rate is of the order of 5% of the volume of corundum particles projected. The presence of these corundum particles on the surface of the part has the same detrimental effects as the powder grains, and can have an impact on the mechanical properties of the part.

Alternatively, dry ice particles can be projected under pressure onto the surface of a part to remove powder grains from the surface of the part before heat treatment. The term “dry ice” refers to carbon dioxide CO2 when it is in solid form. It has the property of vaporising directly without melting, passing from the solid state to the gaseous state, without passing through the liquid state. This technique is similar to sandblasting and allows the roughness to be reduced or powder grains to be removed thanks to the hardness of the dry ice particles. The advantage of dry ice over conventional blasting techniques is that it sublimates after impact due to the thermal energy produced by the impact. The dry ice particles turn into gas and evaporate into the atmosphere immediately. Therefore, unlike conventional sandblasting where the projected corundum particles can become embedded in the surface of the part, dry ice particles do not present a risk of contamination and leave the part clean. The hardness of the dry ice allows the powder grains on the surface of the part to be loosened and the residual powder to be removed without leaving any residue on the surface of the part.

### TECHNICAL PROBLEM

Blasting based on the use of dry ice particles is not effective enough to remove residual powder when the part has already been heat treated. This is because the residual powder has agglomerated on the surface of the part under the thermal effect of a sintering phenomenon. It is then no longer possible to remove it with dry ice blasting alone.

The invention therefore concerns a new blasting medium which allows both the removal of roughness and the removal of powder grains and residual powder present on the surface of a part obtained by additive manufacturing or any other technique. In particular, the proposed new blasting medium is effective in removing residual powder even when the part has been previously heat treated. The new blasting medium therefore offers increased cleaning efficiency while preserving the integrity of the part, in contrast to the blasting medium of the prior art.

### DISCLOSURE OF THE INVENTION

A method is proposed for cleaning and treating the external surfaces of a part with a blasting medium comprising first particles of ice and second particles having a hardness between 2000 and 2500 HV, the said second particles being embedded in the surface and in the volume of the said first particles, the said method comprising a step in which a flow of blasting medium is generated and projected towards an area on the part surface to be treated, the projection speed of the particles being adjusted so as to avoid separation between the second particles and the first particles on impact of the first particles against the surface of the part.

The presence of the first ice particles, which form a protective barrier, means that the second abrasive particles can no longer be directly embedded in the surface of the part. The abrasive particles are then released following the sublimation of the dry ice or the melting of the ordinary ice, leaving the part clean.

Thus, unlike conventional blasting medium where abrasive particles can contaminate the surface of the part by becoming embedded in the surface of the part after blasting, the new medium leaves a clean surface, free of any solid elements inherent in the blasting medium, resulting in a cleaned and treated surface without residue.

The invention can be advantageously supplemented by the following features, taken individually or in any technically possible combination thereof:
- the first particles are water ice particles having a temperature between −10° C. and −20° C.,
- the first particles are dry ice particles having a temperature between −60° C. and −80° C.,
- the proportion of second particles is between 20% and 40% by volume with respect to the first ice particles, preferably between 20% and 30%,
- the second particles are corundum particles,
- the first particles have a diameter between 1 mm and 50 mm, preferably between 20 mm and 30 mm, - the second particles have a diameter between 0.01 mm and 0.5 mm, preferably between 0.1 mm and 0.2 mm.

According to an embodiment of the invention, the projection speed is between 10 m/s and 290 m/s, preferably between 100 m/s and 150 m/s.

Another aspect of the invention relates to a method for manufacturing a blasting medium as defined above, comprising the following steps:
- supplying liquid carbon dioxide;
- subjecting the liquid carbon dioxide to expansion to atmospheric pressure to form dry ice snow;
- sprinkling second particles on the dry ice snow;
- mixing the whole to obtain a first mixture;
- compressing the first mixture to form a dry ice solid with the corundum particles embedded in the surface and in the volume of the said solid;
- extruding the said solid through a plate so as to obtain a cylinder;
- cutting the said cylinder to obtain first dry ice particles with desired dimensions.

The invention can be advantageously supplemented by the following features, taken individually or in any technically possible combination thereof:
- the quantity of second particles introduced into the dry ice snow is between 20% and 40% by volume with respect to the first ice particles, preferably between 20% and 30%,
- the second particles are corundum particles.

### BRIEF DESCRIPTION OF THE DRAWINGS

Further features, details and benefits will emerge from reading the detailed description below, and from the analysis of the attached drawings, on which:

FIG. 1 shows schematically a blasting medium according to an embodiment of the invention used in a method for the surface treatment of a part obtained by additive manufacturing;

FIG. 2 shows the condition of the treated surface of the part with the first dry ice particles embedded after treatment;

FIG. 3 shows the condition of the treated surface of the part after the first dry ice particles have melted.

### DESCRIPTION OF DIFFERENT EMBODIMENTS

The drawings and the description below contain, for the most part, elements of a definite nature. They can therefore serve not only to improve understanding of the present invention, but also contribute to its definition, where appropriate.

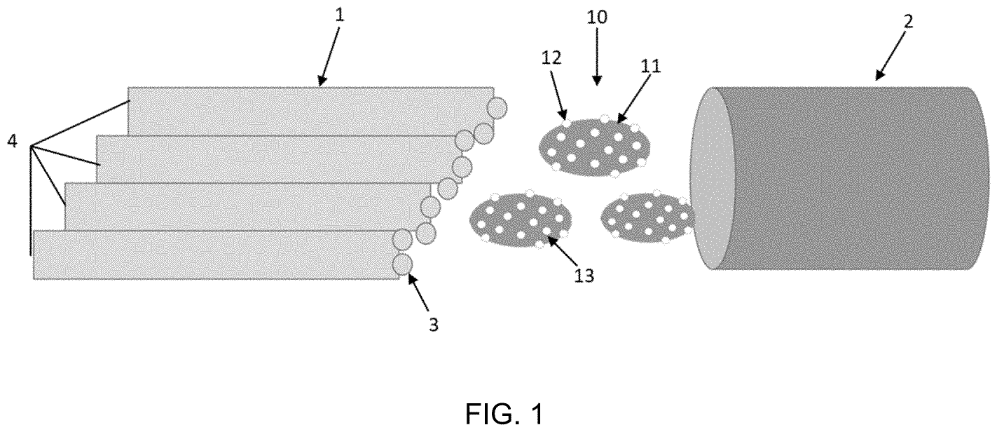

FIG. 1 schematically illustrates a new blasting medium 10 according to one embodiment of the invention. The medium is projected in a stream of compressed air by a suitable device 2 such as a gun towards a surface to be treated of a roughened part 1 obtained for example by additive manufacturing.

The rough part 1 consists of a succession of layers 4 forming steps. In addition, powders 3 are agglomerated on the surface of the steps.

The medium 10 comprises a plurality of first ice particles 11 and second abrasive particles 12 which are embedded in the surface and volume of the first particles.

In one embodiment of the invention, the first ice particles are dry ice particles obtained from liquid CO2. The dry ice particles sublimate on contact with the surface of the part and evaporate as a gas, leaving no residue.

In one embodiment of the invention, the dry ice particles are in the form of sticks, so-called pellets, having a length between 1 mm and 60 mm and a diameter between 1 mm and 50 mm, preferably between 20 mm and 30 mm. They can also be ellipsoidal in shape as in the example shown in FIG. 1.

Advantageously, the first dry ice particles have a temperature between −60° C. and −80° C. In one embodiment, the first ice particles can also be water ice particles obtained from frozen water. The ice particles are projected onto the surface of the part and melt under the effect of heat upon contact with the surface and the resulting liquid evaporates leaving no residue. The first particles are water ice particles with a temperature between −10° C. and −20° C.

Dry ice particles are known to be projected onto a surface to be treated in a part to perform dry ice cleaning. The effectiveness of surface treatment and cleaning is based on the combination of three effects:
- mechanical effect due to the kinetic energy of the dry ice particles at the moment of impact on the part;
- thermal effect due to the temperature of the particles, the residue becomes brittle and shrinks;
- blast effect created by the sublimation of the dry ice which causes the residue to lift off.

However, treatment with dry ice particles alone is not effective in reducing roughness and/or removing powders that have agglomerated on the surface of a previously heat-treated part. The authors of the present invention have found a way to solve this problem, by means of a new blasting medium that combines dry ice particles with abrasive particles having a hardness between 2000 HV and 2500 HV that are embedded in the surface and volume of the dry ice particles.

This new medium combines the effects of the dry ice particles mentioned above with the abrasive power of the second particles to reduce roughness and remove agglomerated powders.

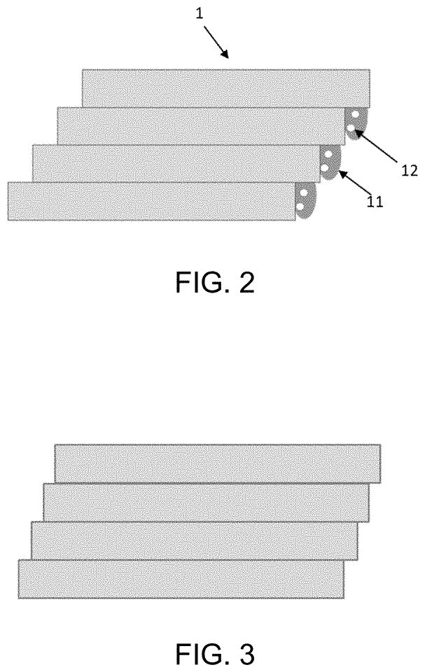

In addition, the presence of dry ice particles, which form a protective barrier, means that abrasive particles can no longer be directly embedded in the surface of the part. They are carried by the dry ice particles that are embedded in the surface of the treated part following blasting as shown in FIG. 2. The abrasive particles are then released following the sublimation of the dry ice or the melting of the ordinary ice, leaving the part clean.

Thus, unlike conventional blasting media where abrasive particles can contaminate the surface of the part by becoming embedded in the surface of the part after blasting, the new medium leaves a clean surface as illustrated in FIG. 3, free of any solid elements inherent in the blasting medium, resulting in a cleaned and treated surface without residue.

According to the invention, the second abrasive particles preferably have a hardness between 2000 HV and 2500 HV.

They have a diameter between 0.01 mm and 0.5 mm, preferably between 0.1 mm and 0.2 mm.

Preferably, the second particles comprise corundum particles.

Advantageously, the proportion of second particles of the second particles is between 20% and 40% by volume in relation to the first ice particles, preferably between 20% and 30%. The method of making the new medium comprising first dry ice particles and second abrasive particles embedded in the surface and volume of the first particles will now be described.

A first step of the method consists in obtaining CO2 snow by expansion from the liquid carbon dioxide contained in a enclosure. Pressurised liquid CO2 is introduced into an enclosure. The pressure inside the enclosure is at or near atmospheric pressure. The pressurised liquid CO2 stream undergoes an expansion inside the enclosure with an accompanying temperature drop to form a solid CO2 snow.

In a second step, corundum particles or other abrasive particles with a hardness between 2000 HV and 2500 HV are sprinkled on the dry ice snow and mixed with the CO2 snow to obtain a first mixture.

In a third step, this first mixture is then fed into compacting and extruding means to form a compacted solid mixture of CO2 with corundum particles embedded in the solid CO2.

In a fourth step, the compacted solid is then pressed through an extruded plate to form cylinders which are subdivided into dry ice rods or pellets with the corundum particles embedded in the surface and volume of the dry ice pellets.

An example of a method for surface treatment of a part using a blasting medium of the present invention will now be described, assuming that the first particles are dry ice particles.

It comprises (irrespective of the type of first particles) a step in which a stream of blasting medium is generated and projected towards an area of the surface to be treated of the part. Under the effect of compressed air, the first particles or pellets of dry ice are accelerated to a predetermined speed. This speed is adjusted so as to avoid separation between the second particles and the first particles during the projection phase and on impact of the first particles against the surface of the part. The projection speed is between 10 m/s and 290 m/s, preferably between 100 m/s and 150 m/s. Tests are carried out to determine the optimum speed.

Before starting the treatment and cleaning of the surface of a part, parameters must be predefined: the dimensions of the first and second dry ice particles, the projection speed at the outlet of the blasting device nozzle, the projection pressure and the projection rate. The projection rate is between 10 kg/h and 100 kg/h.

So if the first particles are dry ice particles, thanks to this high speed and a very low temperature between −60° C. and −80° C., the impurities freeze and the cracks appear. The pellets penetrate this crack, burst and thus loosen the deposits. This dry ice cleaning effect is combined with the abrasive action of the abrasive particles embedded in the dry ice pellets to remove sintered powders from the surface of the heat treated part.

The combined action of dry ice pellets and abrasive particles removes agglomerated and sintered powders from the surface of the heat treated part, leaving the part clean after the operation.

### INDUSTRIAL APPLICATION

The invention can be applied in particular to the field of cleaning and treatment of parts, in particular parts obtained by additive manufacturing to remove the roughness and powder residues specific to additive manufacturing.

1. A method for cleaning and treating an external surface of a part by using a blasting medium comprising first particles of ice and second particles having a hardness between 2000 and 2500 HV, said second particles being embedded in a surface and in a volume of said first particles, said method comprising a step in which a flow of blasting medium is generated and projected towards an area of the external surface of said part, the blasting medium having a projection speed adjusted to avoid separation between the second particles and the first particles on impact of the first particles against the external surface of the part.

2. The method according to claim 1, wherein the first particles are water ice particles having a temperature between −10° C. and −20° C.

3. The method according to claim 1, wherein the first particles are dry ice particles having a temperature between 60° C. and −80° C.

4. The method according to claim 1, wherein the second particles are in a proportion of between 20 to 40% by volume of the first ice particles.

5. The method according to claim 1, wherein the second particles are corundum particles.

6. The method according to claim 1, wherein the first particles have a diameter between 1 mm and 50 mm.

7. The method according to claim 1, wherein the first particles have a diameter between 0.01 mm and 0.5 mm.

8. The method according to claim 1, wherein said projection speed is between 10 m/s and 290 m/s.

9. The method according to claim 1, wherein said projection speed is between 100 m/s and 150 m/s.

10. A method for manufacturing the blasting medium used in the method according to claim 1, comprising the steps of:
supplying liquid carbon dioxide;
subjecting the liquid carbon dioxide to expansion to atmospheric pressure to form dry ice snow;
sprinkling second particles on the dry ice snow, with a quantity of second particles introduced into the dry ice snow between 20 and 40% by volume with respect to the first ice particles;
mixing the whole to obtain a first mixture;
compressing the first mixture to form a dry ice solid with the second particles embedded in a surface and in the volume of said solid;
extruding said solid through a plate so as to obtain a cylinder; and
cutting said cylinder to obtain first dry ice particles with desired dimensions.

11. The method according to claim 10, wherein the second particles are corundum particles.

12. The method according to claim 1, wherein the second particles are in a proportion of between 20 to 30% by volume of the first ice particles.

13. The method according to claim 1, wherein the first particles have a diameter between 20 mm and 30 mm.

14. The method according to claim 1, wherein the first particles have a diameter between 0.1 mm and 0.2 mm.

15. The method according to claim 10, wherein the second particles are in a proportion of between 20 to 30% by volume of the first ice particles.
